(19) United States
(12) Patent Application Publication
(10) Pub. No.: US 2002/0175895 A1
(43) Pub. Date: Nov. 28, 2002

(54) OSD (on screen display) cursor display method and OSD image display apparatus

(76) Inventor: Sung Lyong Lee, Seoul (KR)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/840,455

(22) Filed: Apr. 24, 2001

(30) Foreign Application Priority Data
Apr. 24, 2000 (KR) 2000-21557

(51) Int. Cl. G09G 5/08

(52) U.S. Cl. 345/158

(57) ABSTRACT

An OSD cursor display method and an OSD image display apparatus are provided, wherein an OSD source transmits OSD cursor display data to a display apparatus, said display apparatus stores the received OSD cursor display data in a memory, said OSD source transmits only cursor display location information to said display apparatus, and said display apparatus displays the cursor display data stored in said memory at the received cursor display location. Therefore, since the OSD source only transmits OSD cursor data initially, and thereafter transmits only cursor display location information to the display apparatus, the amount of data in transmission is reduced and thus the processing speed becomes faster, and therefore the location moving time in moving a cursor on a screen becomes faster and the movement of the cursor becomes smooth.

### BACKGROUND OF THE INVENTION

1. Field of the Invention

The present invention relates to an OSD cursor display method and an OSD image display apparatus, particularly to a method and an apparatus that can display an OSD cursor transmitted from an OSD source to a display apparatus more smoothly. The present application is based on Korean Patent Application No. 2000-21557, which is incorporated herein by reference.

2. Description of the Related Art

A digital television (DTV) is provided with not only a digital television image signal received through its own tuner, but also image information from various sources, for display on a screen. That is, a DTV, for example, is provided with a television signal provided from a satellite through a satellite broadcast receiver, such as a set top box (STB) or a cable converter, an image signal reproduced from a digital video disc (DVD) player, and an image signal reproduced from a digital video cassette recorder (DVCR) through an IEEE 1394 bus. The DTV 1394 interface standard is specified in the EIA-775 standard series. Here, a source providing an image signal is defined as a producer, and an apparatus receiving and displaying an image signal like DTV is defined as a consumer. In the DTV 1394 standard, an image signal is provided to a consumer in an MPEG transport stream, and OSD data is provided to a consumer in a bitmap format. Also, producer and consumer exchange a control signal and a state signal.

In general, a producer and a consumer each adopt a separate remote controller for a user interface. Therefore, the user interface of a consumer is made to interactively control the consumer while displaying in an OSD screen through a remote controller. But, although a producer is made to interactively control the producer while displaying in an OSD screen through a remote controller, the OSD screen is actually displayed through a DTV. Therefore, if the amount of OSD data transmitted between the producer and the consumer is large, by receiving OSD data of the producer in the consumer, an adaptive display of a displayed screen becomes difficult, according to the excessive amount of processed data for displaying. That is, the change and movement of an image can be unnatural enough for a viewer to visually observe. This phenomenon acts to reduce the value of a product.

Particularly, a smooth operation of an OSD screen becomes more important in evaluating the value of a product, as the user interface of the product becomes more convenient and the function becomes more diverse.

### SUMMARY OF THE INVENTION

The present invention has been completed in view of the above-described problems involved in the prior art, and it is an object of the present invention to provide an OSD cursor display method and an OSD image display apparatus which can display OSD display data provided from an OSD source faster and more smoothly in a display apparatus, by transmitting the OSD cursor display data in early stages, and then transmitting only cursor display location information.

According to one aspect of the present invention, the method of the present invention comprises the steps of transmitting OSD cursor display data to a display apparatus from an OSD source, storing the received OSD cursor display data in a memory of said display apparatus, transmitting only cursor display location information to said display apparatus from said OSD source, and displaying the cursor display data stored in said memory at the received cursor display location.

According to another aspect of the present invention, the apparatus of the present invention comprises an OSD source remote controller for generating a cursor display command on a screen; an OSD source which transmits OSD cursor display data first, if the cursor display command is received from said OSD source remote controller, and then transmits only cursor display location information; and a display apparatus which stores the OSD cursor display data received from said OSD source in a memory, and displays the cursor display data on the screen by reading the cursor display data stored in said memory in response to the received cursor display location information.

According to the present invention, because only the display location information of the cursor is to be transmitted in transmitting the OSD cursor display data between the producer and the consumer, the amount of data transmission is reduced. Therefore, because the amount of data to be processed in the consumer is reduced, it is possible to display an OSD cursor of the producer on a screen of the consumer at high speed.

### BRIEF DESCRIPTION OF THE DRAWINGS

Further objects and advantages of the invention can be more fully understood from the following detailed description taken in conjunction with the accompanying drawings in which;

FIG. I is a drawing showing one embodiment of an OSD image display apparatus according to the present invention;

FIG. 2 is a circuit diagram to illustrate the operation of FIG. 1;

FIG. 3 is a drawing showing a data structure of an output asynchronous plug register (OAPR) of a producer according to the present invention;

FIG. 4 is a drawing showing a sub frame structure of initial OSD cursor display data according to the present invention; and

FIG. 5 is a drawing showing an OSD cursor ID sub frame structure transmitted from a producer to a consumer according to the present invention.

### DETAILED DESCRIPTION OF PREFERRED EMBODIMENTS

The present invention will hereinafter be described in detail through one embodiment of the present invention, with reference to the accompanying drawings.

FIG. 1 shows one embodiment of an OSD image display apparatus according to the present invention.

A set top box 100 and a producer receive a digital satellite broadcast signal provided from a satellite through a satellite antenna 104 connected through a coaxial cable 102. The set top box 100 detects an MPEG transport stream from the received satellite broadcast signal and then provides the detected MPEG transport stream to a DTV 300 through a DTV 1394 bus 200.

The set top box 100 inputs a command generated through a remote controller 110 through a remote controller receiving part 112. Corresponding OSD data is generated in response to the inputted command and is provided to the DTV 300 through the DTV 1394 bus 200.

The DTV 300 recovers an image signal by decoding the received MPEG transport stream through an MPEG decoder, and displays on a screen by overlapping the recovered image signal and the received OSD data. Therefore, a user can control an STB 100 while viewing an OSD screen of the STB displayed on a screen of the DTV by using the remote controller for the set top box.

The DTV 300 is controlled through a DTV remote controller 310.

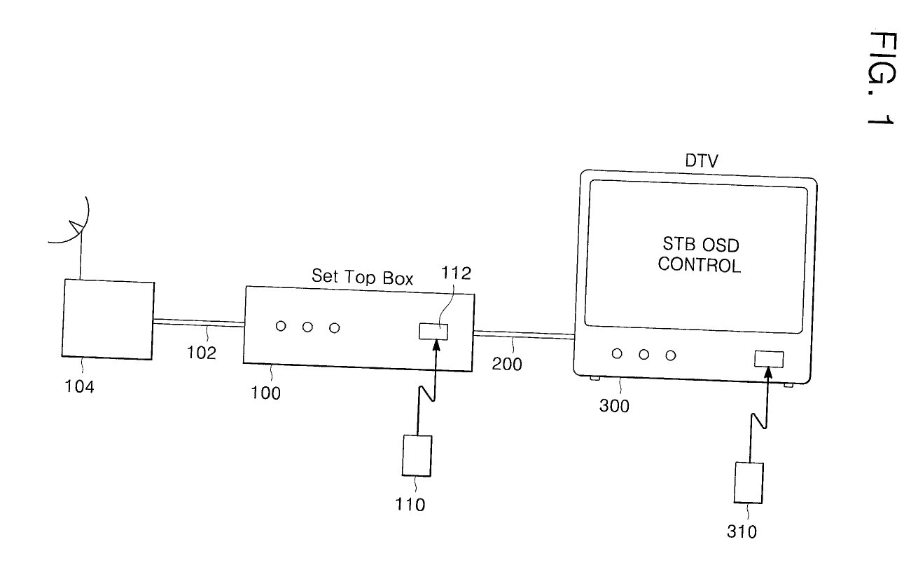

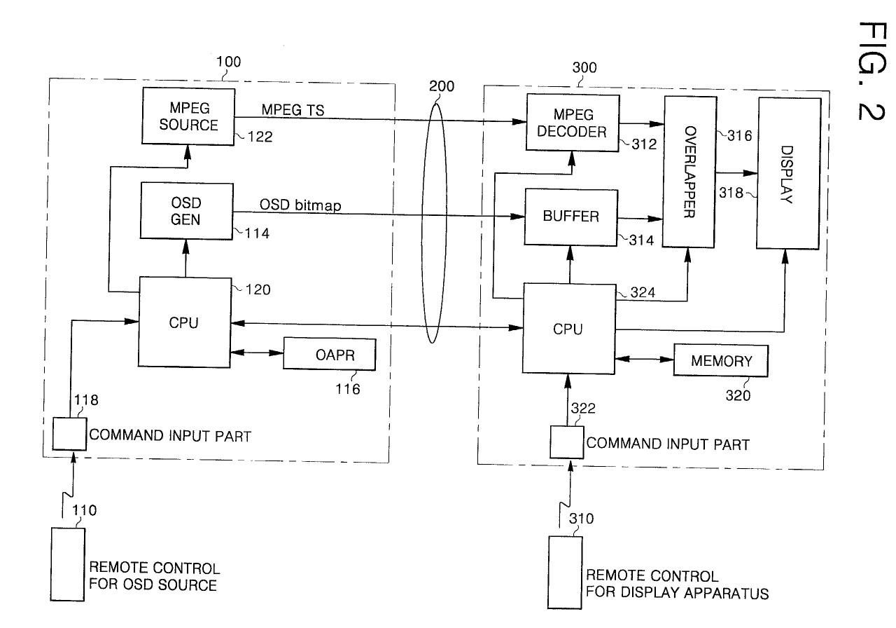

FIG. 2 shows a circuit block diagram to illustrate the operation of FIG. 1.

The set top box 100 and the DTV 300 are interconnected with a DTV 1394 bus 200.

The set top box 100 includes an MPEG source 112, an OSD generator 114, an output asynchronous plug register (OAPR) 116, a command input part 118 and a control part 120. The command input part 118 receives a command signal generated by the remote controller 110 and provides the command signal to the control part 120. The MPEG source detects an MPEG transport stream by inputting a satellite broadcast signal in response to the control of the control part 120 and provides the detected MPEG transport stream to the DTV 300. The OSD generator 114 generates OSD display data in bitmap format in response to the control of the control part 120.

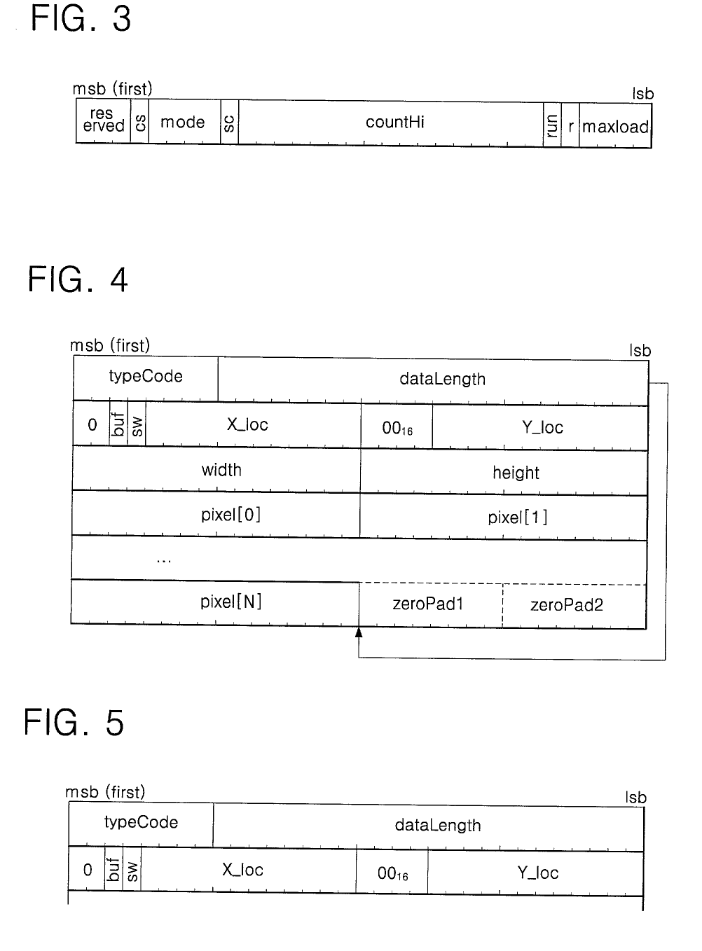

The output asynchronous plug register (OAPR) 116 stores four bytes of data as shown in FIG. 3. The data structure of the output asynchronous plug register (OAPR) in FIG. 3 is as shown in Table 1.

TABLE 1

| CLASSIFICATION | DESCRIPTION |
|---|---|
| RESERVED | 0 |
| CS | BIT INDICATING POSSIBILITY OF |
| | CURSOR SAVE |
| MODE | 0:FREE, 1:RESERVED, 2:SUSPEND, |
| | 3:RESERVED, 4:RESUME |
| | 5:SEND, 6˜7:RESERVED, |
| SC | TOGGLE BIT |
| COUNTHi | 18 BITS COUNT VALUE |
| RUN | |
| RESERVED | 0 |
| MAX LOAD | INDICATE DATA-PAYLOAD SIZE FOR |
| | ENTERING 4 BITS SEGMENT BUFFER |

According to the present invention, the output asynchronous plug register (OAPR) information is provided from the DTV to the STB in initial connection of the STB 100 and the DTV 300. Then, in case of a DTV having an own OSD object data save possibility indicating data, if the OSD object data save possibility information is provided to the STB 100, the STB sets the CS bit of cursor data save possibility indicating bit as “1”.

OSD cursor data are transmitted from the STB 100 to the DTV 300. First, the OSD cursor display data in FIG. 4 are transmitted as cursor data, and then the OSD cursor ID data in FIG. 5 are transmitted.

The DTV 300 includes an MPEG decoder 312, a buffer 314, an overlapper 316, an image display 318, a memory 320, a command input part 322 and a control part 324. The MPEG decoder 312 outputs image data to the overlapper 316 by extending a compression-coded image data by inputting an MPEG transport stream. The buffer 314 buffers the provided OSD data and provides the corresponding OSD data to the overlapper 316 in response to the control of the control part 324. The overlapper 316 overlaps the image data and the OSD data and provides this overlapped data to the image display 318. The memory 320 stores the OSD display data provided from the STB 100. The command input part 322 receives a command signal generated from the remote controller 310 and provides the command signal to the control part 324.

The STB 100 generates and transmits the sub frame of the OSD cursor display data in FIG. 4 first, by controlling the OSD generator 114 through the control part 120 if an OSD cursor display command is inputted through the remote controller 110.

A sub frame of the OSD cursor display data in FIG. 4 includes TYPECODE of one byte, data length of three bytes, BUF of one bit, SW of one bit, 12 bits X coordinate value of a cursor display location, 12 bits Y coordinate value of a cursor display location, cursor display width of 2 bytes, cursor display height of 2 bytes, and a plurality of 2 bytes cursor pixel data. TYPECODE of said sub frame has a value of “0XF0” for example. The cursor pixel data are bitmap data. Here, “0X” of “0XF0” indicates HEXA CODE. Therefore, “F0” indicates the value of HEXA CODE.

In the DTV 300, the OSD cursor display data sub frame transmitted through the bus 200 is stored in the buffer 314 temporarily.

In the control part 324, TYPECODE of the sub frame stored in the buffer 314 is analyzed and, if the TYPECODE is “0XF0”, the OSD cursor display data stored in the buffer 314 is stored in the memory 320. And, the received cursor display data is displayed at a given XY location.

After transmitting the OSD cursor display data sub frame, the STB 100 outputs OSD cursor display information by providing a control signal to the OSD generator 114. Then, the OSD cursor display information includes only cursor display location information or cursor ID information of 8 bytes as shown in FIG. 5.

The cursor ID information sub frame includes TYPECODE of one byte, data length of three bytes, BUF of one bit, SW of one bit, 12 bits X coordinate value of a cursor display location and 12 bits Y coordinate value of a cursor display location. The location information of the cursor is set as TYPECODE “0XF1” and is constituted with four bytes including X and Y location information. BUF has a value of “0”, and SW has a value of “0”. “00” of BUF and SW is a control code for locating cursor display data in the buffer 314 promptly in the consumer. That is, the cursor ID information has TYPECODE of a different value from the cursor bitmap information.

Therefore, the DTV 300 analyzes the sub frame in FIG. 5 received in the buffer 314, and if the TYPECODE value is “0XF1”, analyzes as a next display location information of the cursor whose OSD cursor display data is already received and stored in the memory. And after reading the cursor display data stored in the memory 320 and storing promptly said cursor display data in the buffer 314, the DTV displays the cursor display data stored in the buffer 314 at a screen location designated with given X and Y coordinate values.

Therefore, according to the present invention, the STB 100 does not send the whole OSD cursor display data in bitmap format at every cursor location movement to the DTV 300. If the whole OSD cursor display data is sent in early stages, and then only the cursor display location information is sent, the STB 300 reads the cursor display data received first and displays the cursor display data at a given location on the screen. Therefore, because the amount of data reception and transmission between the STB 100 and the DTV 300 is largely reduced, the movement of the cursor on the screen can be displayed very fast, and, thus, it can be viewed very naturally by a user.

As described above, because only the display location information of the cursor is to be transmitted in transmitting the OSD cursor display data between the producer and the consumer, the amount of data transmission is reduced. Therefore, because the amount of data to be processed in the consumer is reduced, it is possible to display an OSD cursor of the producer on a screen of the consumer at high speed.

While the present invention has been described with respect to the particular embodiments, it will be apparent to those skilled in the art that various changes and modifications may be made without departing from the spirit and scope of the invention as defined in the following claims.

What is claimed is:

1. An OSD cursor display method, comprising the steps of:
transmitting OSD cursor display data to a display apparatus from an OSD source;
storing received OSD cursor display data in a memory in the display apparatus;
transmitting only cursor display location information to the display apparatus from the OSD source; and
displaying the cursor display data stored in the memory at a received cursor display location in the display apparatus.

2. The OSD cursor display method according to claim 1, further comprising a step of:
checking whether the display apparatus is a product which can store OSD cursor display data before the OSD source transmits OSD cursor display data to the display apparatus.

3. An OSD image display apparatus, comprising:
an OSD source remote controller for generating a cursor display command on a screen;
an OSD source for initially transmitting OSD cursor display data if the cursor display command is received from the OSD source remote controller, and thereafter transmitting only cursor display location information; and
a display apparatus for storing the OSD cursor display data transmitted by the OSD source in a memory, and displaying the cursor display data on the screen by reading the cursor display data stored in the memory in response to the cursor display location information.

4. The OSD image display apparatus of claim 3, further comprising:
a storage device for setting display information indicating that the OSD source is a product which can store OSD cursor display data provided from the display apparatus.

5. The OSD image display apparatus of claim 4, wherein the storage device is a register.

6. The OSD image display apparatus of claim 5, wherein the register is an output asynchronous plug register.

7. The OSD image display apparatus of claim 3, wherein the OSD source comprises:
an MPEG source for supplying an MPEG transport stream to the display apparatus;
an OSD generator for generating OSD display data in bitmap format; and
a controller for controlling the MPEG source and the OSD generator.

8. The OSD image display apparatus of claim 7, wherein the OSD source further comprises:
a command input part for receiving a command signal from the OSD source remote controller and providing the command signal to the controller.

9. The OSD image display apparatus of claim 3, wherein the display apparatus comprises:
an MPEG decoder for decoding an MPEG transport stream and outputting image data;
a buffer for buffering OSD data;
an overlapper for overlapping the image data and the OSD data and providing overlapped data to the screen; and
a controller for controlling the MPEG decoder, the buffer, the overlapper, the memory, and the screen.

10. The OSD image display apparatus of claim 9, wherein the OSD image display apparatus further comprises:
a display apparatus remote controller.

11. The OSD image display apparatus of claim 10, wherein the display apparatus further comprises:
a command input part for receiving a command signal from the display apparatus remote controller and providing the command signal to the controller.
